(19) United States
(12) Patent Application Publication
(10) Pub. No.: US 2017/0022928 A1
(43) Pub. Date: Jan. 26, 2017

(54) CONTROL METHOD OF FUEL INJECTION INJECTOR AND THE CONTROL SYSTEM THEREOF

(71) Applicants: HYUNDAI MOTOR COMPANY, Seoul (KR); KIA MOTORS CORPORATION, Seoul (KR)

(72) Inventor: Jeong Sik JIN, Ansan-si (KR)

(73) Assignees: HYUNDAI MOTOR COMPANY, Seoul (KR); KIA MOTORS CORPORATION, Seoul (KR)

(21) Appl. No.: 14/926,632

(22) Filed: Oct. 29, 2015

(30) Foreign Application Priority Data
Jul. 21, 2015 (KR) 10-2015-0103219

(51) Int. Cl. F02D 41/40; F02M 51/06; F02M 61/10; F02D 41/30

(52) U.S. Cl. CPC F02D 41/401; F02D 41/3005; F02M 51/0603; F02M 51/061; F02M 61/10

(57) ABSTRACT

A control method of a fuel injection injector may include: detecting a first current which is applied to an injector, detecting a first voltage which is generated in the injector; calculating an opening timing of the injector using a variation characteristic of the first current; and calculating a closing timing of the injector using a variation characteristic of the first voltage. The method may further include: calculating an actual fuel injection amount through an opening duration between the opening timing and the closing timing; and correcting the closing timing or the opening timing of the injector based upon a difference in value between the actual fuel injection amount and a target fuel injection amount.

### CROSS-REFERENCE TO RELATED APPLICATIONS

This application claims priority to Korean Patent Application No. 10-2015-0103219, filed in the Korean Intellectual Property Office on Jul. 21, 2015, the entire contents of which is incorporated herein by reference.

### BACKGROUND

The present disclosure relates to control methods of fuel injection injectors, including control methods which control a closing time and an opening time of an injector, to control a fuel injection amount based on a difference in value between an actual fuel injection amount and a target fuel injection amount.

### FIELD

Currently, a common rail type injecting apparatus, which is electronically controlled, is usually employed for a diesel engine for a passenger car. Such an injecting apparatus electronically controls an injecting system to more precisely inject a fuel at a high pressure.

However, the common rail type injecting apparatus has a problem in that the injection is performed toward all cylinders at the same injection timing, so that a difference generated between the cylinders may not be corrected.

For example, a fuel injection timing of a diesel in-line 4 cylinder engine is determined based on a crank angle while ignoring a difference between cylinders, so that the fuel injection timing is determined by mapping an engine RPM to a fuel amount.

In this case, a difference between combustion pressures may occur due to a difference caused by an air amount for every cylinder or by a deviation between injectors, and thus irregular vibration may occur. Therefore, riding comfort is not good and there may be a difference between effective average pressures generated for the cylinders.

In other words, theoretically, the fuel is injected at the same interval between the cylinders, but locations of a peak pressure are not formed at the same interval due to a deviation between injectors and a deviation between cylinders and thus there may be a difference between the locations due to a variation between cylinders.

Further, exhaust gas is strictly restricted so that a post processing technology is developed in order to cope with the restriction of the exhaust gas. Further, the fuel injection needs to be more precisely controlled in order to precisely control the post processing.

The above information disclosed in this Background section is only for enhancement of understanding of the background of the invention and therefore it may contain information that is not prior art already known to a person of ordinary skill in the art.

### SUMMARY

The present disclosure has been made in an effort to provide a control method of a fuel injection injector which more precisely controls fuel injected from an injector to improve a quality of an exhaust gas and improve noise and vibration, and in an effort to provide a control method of a fuel injection injector which detects an opening timing and a closing timing of the injector.

An exemplary form of the present disclosure provides a control method of a fuel injection injector including: detecting a first current which is applied to an injector; detecting a first voltage which is generated in the injector; calculating an opening timing of the injector using a variation characteristic of the first current; and calculating a closing timing of the injector using a variation characteristic of the first voltage.

The method may further include: calculating an actual fuel injection amount through an opening duration between the opening timing and the closing timing; and correcting the closing timing or the opening timing of the injector based upon a difference in value between the actual fuel injection amount and a target fuel injection amount.

The method may further include generating a failure signal of the injector when it is determined that the difference in value exceeds a predetermined value.

The method may further include delaying the closing timing when it is determined that the target fuel injection amount is larger than the actual fuel injection amount.

The method may further include advancing the closing timing when it is determined that the target fuel injection amount is smaller than the actual fuel injection amount.

The method may further include advancing the opening timing when it is determined that the target fuel injection amount is larger than the actual fuel injection amount or delaying the opening timing when it is determined that the target fuel injection amount is smaller than the actual fuel injection amount.

The opening timing may correspond to an inflection point at which the first current rises and then falls.

The closing timing may correspond to an inflection point at which the first voltage falls and then rises.

The method may further include detecting a fuel pressure of a fuel which is supplied to the injector and the actual fuel injection amount may be calculated using the fuel pressure and an opening duration.

An exemplary form of the present disclosure provides a control system of a fuel injection injector including: an injector which is disposed to inject fuel into a combustion chamber; a fuel pump which is disposed to pump the fuel to the injector at a predetermined pressure; and a control unit which is configured to control the injector and the fuel pump in order to perform the method.

The control unit is configured detect a current which is applied to the injector, and a voltage which is generated in the injector, using an analog to digital converter (ADC).

The control system may further include a pressure sensor which is configured to detect a pressure of fuel which is pumped to the injector.

The injector may generate lift displacement based upon a current which is applied as a piezo type.

In an exemplary form of the present disclosure, the opening timing and the closing timing of the injector may be detected through the current which is applied to the injector and the voltage which is generated in the injector, and the actual fuel injection amount may be calculated therethrough.

Further, the closing timing or the opening timing of the injector may be controlled based upon a difference in value between the actual fuel injection amount and the target fuel injection amount, thereby more precisely correcting the fuel injection.

Further, it is easily determined whether the injector is out of order, based upon the difference in value between the target fuel injection amount and the actual injection amount of the injector.

### DRAWINGS

FIG. 1 is a schematic diagram of a control system of a fuel injection injector.

FIG. 2 is a graph illustrating a relationship between lift of a fuel injection injector and an applied current.

FIG. 3 is a graph illustrating a voltage and pressure change formed in a fuel injection injector.

FIG. 4 is a graph illustrating an effect of a control method of a fuel injection injector.

FIG. 5 is a flowchart illustrating a control method of a fuel injection injector.

### DETAILED DESCRIPTION

One or more exemplary aspects of the present disclosure will hereinafter be described in detail with reference to the accompanying drawings.

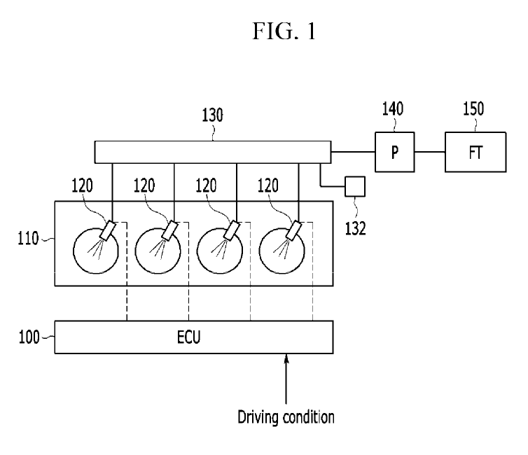

FIG. 1 is a schematic diagram of a control system of a fuel injection injector.

A control system of an injector includes a fuel tank 150, a fuel pump 140, a rail 130, a pressure sensor 132, an injector 120, an engine 110, and a control unit 100.

Fuel which is used for an internal combustion engine is filled in the fuel tank 150 and the fuel pump 140 pumps the fuel from the fuel tank 150 to the rail 130. In the rail 130, a pressure sensor 132 that is configured to detect an internal pressure is disposed, and a regulator valve (not illustrated) and a return line (not illustrated) are separately formed.

The fuel which is pumped to the rail 130 is distributed to the injector 120. The injector 120 is disposed to correspond to cylinders so as to inject the fuel into a combustion chamber of the engine 110.

The control unit 100 may select a driving condition, for example, a target fuel injection amount and an opening timing of the injector based upon a rotation speed of the engine and an accelerator pedal signal, and control a closing timing of the injector 120 based upon the selected target fuel injection amount.

In an exemplary form of the present disclosure, the control unit 100 applies current to the injector 120 to control operation of the injector 120, receives a pressure signal from the pressure sensor 132 to detect a fuel injection pressure, and detects the voltage formed in the injector 120.

The control unit 100 detects the opening timing of the injector 120 through a peak point of current which is applied to the injector 120, detects the closing timing of the injector 120 through a voltage generated in the injector 120, and calculates an actual fuel injection amount through the opening timing, the closing timing, and a fuel pressure.

Further, the control unit 100 compares the actual fuel injection amount and the target fuel injection amount, calculates a difference in value therebetween, and corrects the opening timing and the closing timing of the injector 120 based upon the difference in value to correctly correct the fuel injection amount of the injector 120.

Further, when it is determined that the difference in value exceeds a predetermined value, the control unit 100 may determine that the injector 120 does not operate normally.

In an exemplary form of the present disclosure, the control unit 100 may be implemented by at least one microprocessor that operates by a predetermined program. The predetermined program may include a series of commands which perform a method according to an exemplary form of the present disclosure which will be described below.

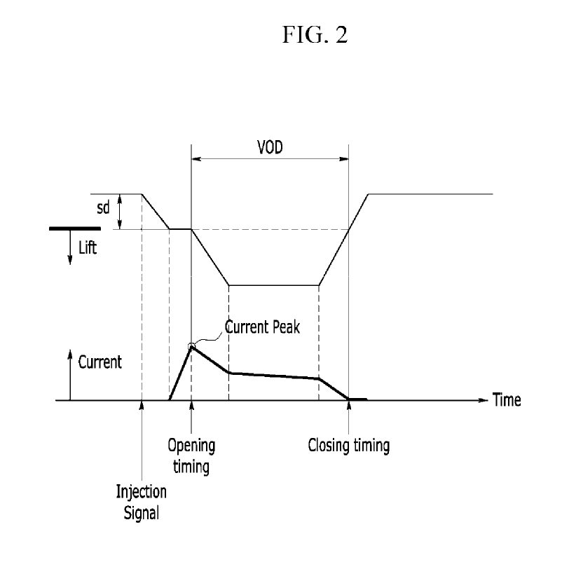

FIG. 2 is a graph illustrating a relationship between lift of a fuel injection injector.

In FIG. 2, a horizontal axis represents a time and a vertical axis represents an intensity of current and a lifted amount of a needle (not illustrated) provided in the injector 120.

Sd refers to a dead stroke of a needle. The needle moves but the actual fuel injection nozzle is not open. VOD refers to a valve opening duration.

In order for the injector 120 to inject the fuel, the needle needs to be lifted. In order to lift the needle, the current needs to be applied to a solenoid or a piezo.

In order to apply the current, an initial signal is generated, the current is applied to the solenoid or the piezo of the injector 120 with a predetermined delay time from the initial signal, and the intensity of the current is gradually increased to reach the current peak.

As illustrated in the drawing, an act in which the current is increased to reach the current peak and then is decreased again is performed and the needle is lifted at the current peak and during a valve opening duration (VOD).

In an exemplary form of the present disclosure, the current which is applied to the injector 120 is precisely detected and the opening timing (actually, a needle lifting timing) of the injector 120 is detected through the peak point of the current.

Further, the closing timing of the needle of the injector 120 corresponds to a timing at which the current reaches zero. Further, since the intensity of the current is low, it is not easy to detect the closing timing of the needle using the intensity of the current

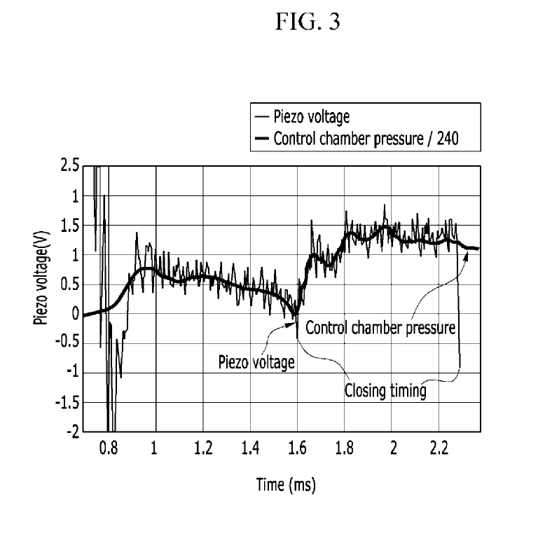

FIG. 3 is a graph illustrating a voltage and pressure change formed in a fuel injection injector.

In FIG. 3, the horizontal axis represents a time and the vertical axis represents a piezo voltage generated in the injector 120 and a control chamber pressure (or an injection pressure) of the fuel.

As illustrated in the drawing, the voltage shows a tendency to be sharply increased and decreased at an initial stage and gradually decreased and then sharply increased again, and a timing when the voltage is gradually decreased and then sharply increased may be detected as a closing timing of the injector 120.

As described above, the closing timing of the injector 120 may be effectively and easily detected based upon a voltage level generated in the injector 120.

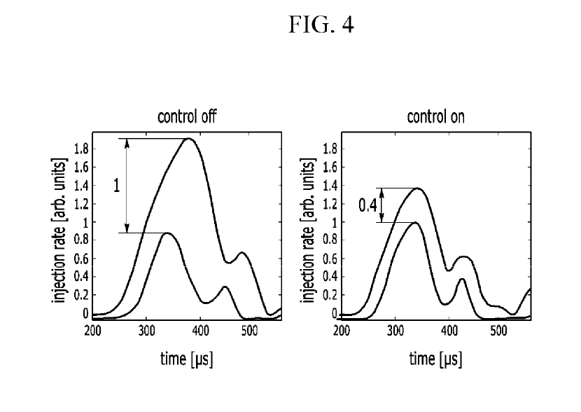

FIG. 4 is a graph illustrating an effect of a control method of a fuel injection injector.

In FIG. 4, the horizontal axis represents a time and the vertical axis represents an injection amount (injection rate).

Here, “control off” illustrates a case when the control unit 100 does not correct the opening timing and the closing timing of the injector 120 and “control on” illustrates a case when the control unit 100 corrects the opening timing and the closing timing of the injector 120.

In a control-off state, a deviation of the fuel injection amount is 1, and in a control-on state a deviation of the fuel injection amount is 0.4.

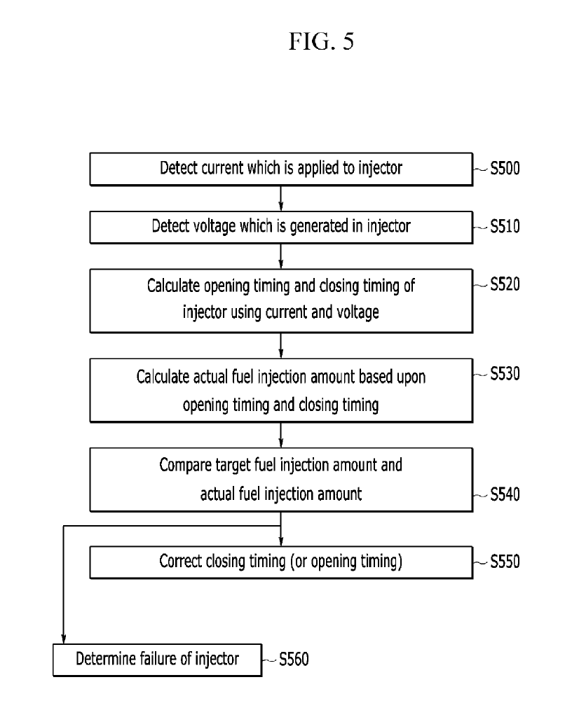

FIG. 5 is a flowchart illustrating a control method of a fuel injection injector.

In FIG. 5, in step S500, a current which is applied to an injector 120 is detected, and in step S510, a voltage which is generated in the injector 120 is detected.

Next, in step S520, an opening timing and a closing timing of the injector 120 is calculated/detected using the detected current and voltage, and in step S530, an actual fuel injection amount is calculated based upon the opening timing and the closing timing which are calculated/detected and a fuel pressure.

Next, in step S540, the calculated actual fuel injection amount and the target fuel injection amount are compared to calculate a difference in value therebetween, and in step S550, the closing timing or the opening timing of the injector 120 is corrected based upon the difference in value.

Further, in step S540, when the difference in value between the actual fuel injection amount and the target fuel injection amount is large, in step S560, it is determined that the injector 120 is out of order.

In an exemplary form of the present disclosure, the opening timing and the closing timing of the injector are detected through the current which is applied to the injector 120 and the voltage which is generated in the injector 120, the actual fuel injection amount is easily calculated therethrough, and the closing timing or the opening timing of the injector 120 is controlled based upon the difference in value between the actual fuel injection amount and the target fuel injection amount, thereby more precisely correcting the fuel injection. Further, it is easily determined whether the injector 120 is out of order, based upon the difference in value between the target fuel injection amount and the actual fuel injection amount of the injector 120.

In an exemplary form of the present disclosure, the control unit has a function of detecting the current which is applied to the injector, and the voltage which is generated in the injector, using an analog to digital converter (ADC), and may be embodied in a microcomputer.

While this invention has been described in connection with what is presently considered to be practical exemplary forms, it is to be understood that the invention is not limited to the disclosed forms, but, on the contrary, is intended to cover various modifications and equivalent arrangements included within the spirit and scope of the appended claims.

What is claimed is:

1. A control method of a fuel injection injector, comprising:
detecting a first current which is applied to an injector;
detecting a first voltage which is generated in the injector;
calculating an opening timing of the injector using a variation characteristic of the first current; and
calculating a closing timing of the injector using a variation characteristic of the first voltage.

2. The control method of claim 1, further comprising:
calculating an actual fuel injection amount through an opening duration between the opening timing and the closing timing; and
correcting the closing timing or the opening timing of the injector based upon a difference in value between the actual fuel injection amount and a target fuel injection amount.

3. The control method of claim 2, further comprising:
generating a failure signal of the injector based upon a determination that the difference in value exceeds a predetermined value.

4. The control method of claim 2, further comprising:
delaying the closing timing based upon a determination that the target fuel injection amount is larger than the actual fuel injection amount.

5. The control method of claim 2, further comprising:
advancing the closing timing based upon a determination that the target fuel injection amount is smaller than the actual fuel injection amount.

6. The control method of claim 2, further comprising:
advancing the opening timing based upon a determination that the target fuel injection amount is larger than the actual fuel injection amount, or
delaying the opening timing based upon a determination that the target fuel injection amount is smaller than the actual fuel injection amount.

7. The control method of claim 1, wherein:
the opening timing corresponds to an inflection point at which the first current rises and then falls.

8. The control method of claim 1, wherein:
the closing timing corresponds to an inflection point at which the first voltage falls and then rises.

9. The control method of claim 1, further comprising:
detecting a fuel pressure of a fuel which is supplied to the injector;
wherein the actual fuel injection amount is calculated using the fuel pressure and an opening duration.

10. A control system of a fuel injection injector, comprising:
an injector which is disposed to inject fuel into a combustion chamber;
a fuel pump which is disposed to pump the fuel to the injector at a predetermined pressure; and
a control unit which is configured to control the injector and the fuel pump and to:
detect a first current which is applied to the injector;
detect a first voltage which is generated in the injector;
calculate an opening timing of the injector using a variation characteristic of the first current; and
calculate a closing timing of the injector using a variation characteristic of the first voltage.

11. The control system of claim 10, wherein:
the control unit is configured to detect a current which is applied to the injector, and a voltage which is generated in the injector, using an analog to digital converter (ADC).

12. The control system of claim 10, further comprising:
a pressure sensor which is disposed to detect a pressure of fuel which is pumped to the injector.

13. The control system of claim 10, wherein:
the injector is configured to generate a lift displacement based upon a current which is applied as a piezo type.
